(19) United States
(12) Patent Application Publication
(10) Pub. No.: US 2009/0225806 A1
(43) Pub. Date: Sep. 10, 2009

(54) Dental Furnace

(75) Inventors: Johannes Lorunser, Bludenz (AT); Gottfried Rohner, Altstatten (CH); Alex Mauerhofer, Maienfeld (CH)

Correspondence Address: John C. Thompson, 69 Grayton Road, Tonawanda, NY, 14150, US

(73) Assignee: Ivoclar Vivadent AG

(21) Appl. No.: 12/386,445

(22) Filed: Apr. 16, 2009

(30) Foreign Application Priority Data
Mar. 5, 2008 (DE) 10 2008 012 579.2

(51) Int. Cl. H05B 3/62; H05B 1/02

(52) U.S. Cl. 373/134; 373/135

(57) ABSTRACT

The invention relates to a dental furnace with a heating chamber, with at least two heating elements acting on the heating chamber and one control apparatus, which interacts with the heating elements, for the voltage supply to the heating elements. The control apparatus (22) supplies at least two heating elements (12) separately with voltage. In addition, the control apparatus (22) matches the power output of at least one heating element (12) to the requirements of the temperature distribution in the heating chamber (30).

### TECHNICAL FIELD

The invention relates to a dental furnace, and more particularly to a dental furnace with a heating chamber which can be heated differently in order thus to set the temperature distribution in the heating chamber in a targeted manner, as is desired.

### BACKGROUND OF THE INVENTION

A dental furnace needs to be controlled precisely in terms of the temperature profile along a so-called “firing curve”, since the quality and the result of the sintering is typically strongly dependent on the firing curve or on the predetermined accuracy being maintained.

For this purpose, complex control apparatuses are known which activate a TRIAC via a line transformer, which TRIAC is activated via the corresponding control apparatus in pulsed form.

One example of such a control apparatus for a dental furnace is known from GB 2006998 A. With this control apparatus, any fluctuations in the feed voltage should be compensated for by accurate pulse activation, in order to realize the voltage supply of heating elements as accurately as possible.

The firing furnace known from GB 2006998 A is comparatively expensive and heavy since the heating power is supplied via a conventional transformer. Furthermore, it is known per se to reduce the size and the weight of the transformer via so-called primary-pulsed switched mode power supplies, whereby the AC voltage which is usually transformed in the frequency range around 50 kHz then needs to be carefully rectified and smoothed in order to provide DC voltages of the required quality.

In this context, it has also already been proposed to use a common primary-pulsed switched mode power supply in a plurality of heating circuits and to provide regulation of the desired heating power on the secondary side.

Typically, firing furnaces for dental sintering material have a furnace hood, in whose inner wall a plurality of heating spirals or heating coils are integrated. Such heating spirals are usually designed to be substantially in the form of a U, and from two to six heating spirals are typically provided. In the case of, for example, six heating spirals, ⅙ of the feed voltage is applied to each heating spiral, and the same current flows through all of the heating spirals.

On the other hand, heating spirals are subjected to manufacturing tolerances which prevent the same heating power also being output precisely given the same heating current supplied.

In order nevertheless to ensure a uniform temperature profile within the heating chamber, it has already been proposed to preselect heating spirals with identical electrical parameters. This is relatively complicated, but on the other hand also does not take into consideration the possibility that the heating spirals experience a change in their electrical parameters during operation, in particular in the case of high-temperature furnaces in which the amount of wear is comparatively high.

The individual manual control of heating spirals is likewise already known in another context.

On the other hand, particularly dental firing furnaces need to process different firing material. The dental materials to be sintered are often embedded in gypsum compositions, with both the size of the muffle used and the quantity of the dental material required for the dental restoration fluctuating within wide ranges.

Typically, large muffles and relatively large quantities of dental materials to this extent have a relatively high thermal capacity and require relatively intensive heating.

Nevertheless, in various experiments it has been shown that even when a relatively high heating power is supplied corresponding to the relatively large mass of the firing material, the firing results are different than in the case of relatively small masses.

### OBJECTS AND SUMMARY OF THE INVENTION

The invention provides that at least two heating elements are controlled in a targeted manner and differently in order thus to set the temperature distribution in the heating chamber in a targeted manner, as is desired.

For example, it is conventional in heating chambers in accordance with the prior art for temperature stratification to occur, i.e. for the upper part of the heating chamber to be hotter than the lower part. According to the invention, this can be compensated for by virtue of the fact that lower heating elements are activated to a greater extent and upper heating elements are activated to a lesser extent. Even different masses of the objects to be fired can be taken into consideration in accordance with the invention in a particularly favorable manner:

As a result of the fact that lower heating elements are heated to a greater extent, convection obviously results in the heating chamber which makes the temperature distribution more uniform and, precisely in the case of more voluminous objects to be fired, realizes the temperature compensation better than in the case of the known firing furnaces.

In accordance with the invention it is particularly favorable if individual activation is realized for the heating elements, which makes use of the fact that electrical switching elements such as TRIACs need to be used in any case for the primary-pulsed operation of switched mode power supplies. This solution is very favorable precisely in the case of, for example, three heating cycles or heating elements arranged one on top of the other. The control via the control apparatus according to the invention is then moved into the primary region of the overall circuit, with the result that the TRIACs which are provided there in any case can be used several times.

In accordance with the invention it is furthermore particularly favorable if heating elements which are arranged at the same height and surround, for example, the heating chamber substantially in the form of a ring are activated by the same control apparatus, in which case, however, it also goes without saying that it is particularly favorable if in each case a separate control apparatus is used for each heating element, which separate control apparatus can certainly also be realized as part of an overall control apparatus.

Precalibration of the heating elements can also be realized in accordance with the invention using individual control apparatuses, with the result that more precise temperature control is possible.

It is also possible to detect the currently present resistance based on the quotient of the voltage and the current for each heating element, which resistance, as is known, ends with the temperature, in order thus to ensure optimized activation.

The power loss for the regulation can be halved by dispensing with the second TRIAC within the control apparatus at least in the semiconductor region, with the result that it substantially comprises the voltage drop across the TRIAC and its switching losses as well as the losses of the transformer.

In accordance with the invention it is also possible in the individual case to provide, if desired, a temperature gradient in the heating chamber. For example, it is conceivable for a plurality of muffles to be fired jointly in a large firing space. In this case, it may be favorable to provide the greatest heating energy adjacent to the largest muffle in order to this extent to compensate for temperature differences.

In a further advantageous embodiment, it is provided that the heating chamber extends substantially in the form of a hollow cylinder, and at least two heating elements are arranged one above the other and can each be controlled separately by the control apparatus.

In a further advantageous embodiment, it is provided that the heating chamber is formed as part of a furnace hood and is substantially closed when the furnace hood is closed.

In a further advantageous embodiment, it is provided that the heating elements are arranged distributed in the region of the heating chamber wall and are protected in particular by a substantially tubular cover disk.

In a further advantageous embodiment, it is provided that the heating elements extend at least partially along the heating chamber wall in the circumferential direction of the heating chamber wall or parallel to the mid-longitudinal axis of the heating chamber wall.

In a further advantageous embodiment, it is provided that at least two temperature sensors are arranged adjacent to the heating elements, but outside the heating chamber, in particular on the side of a quartz glass cover, on which the heating elements are likewise provided.

In a further advantageous embodiment, it is provided that the heating elements tightly adjacent to the heating chamber in the form of heating spirals extend in the form of a ring or in the form of a spiral around the heating chamber.

In a further advantageous embodiment, it is provided that the control apparatus is connected to at least one temperature sensor, which is arranged adjacent to the heating element in the heating chamber and/or spaced apart from the heating element in the heating chamber.

In a further advantageous embodiment, it is provided that heating elements are supplied with an identical or higher power by the control apparatus.

In a further advantageous embodiment, it is provided that the dental furnace is calibrated at at least one temperature in the heating chamber, and that the activation of the heating elements takes place by means of the control apparatus on the basis of temperatures measured by temperature sensors, which heating elements are arranged outside the heating chamber, but are tightly adjacent to it.

In accordance with an alternative embodiment, it is provided that, instead of a sintering furnace, a microwave furnace is used for realizing the dental furnace according to the invention.

In a further advantageous embodiment, it is provided that a temperature of a maximum of 1600° C. can be measured by the sensor.

In a further advantageous embodiment, it is provided that the control apparatus for the power supply to the heating elements has a primary-pulsed switched mode power supply, with a separate circuit being provided in particular for each or a plurality of heating elements, which circuits can be controlled jointly by the control apparatus.

In a further advantageous embodiment, it is provided that DC voltage, which has a residual ripple of 1% or less, preferably of less than 0.1%, is applied to the heating elements.

In a further advantageous embodiment, it is provided that the heating elements substantially comprise molybdenum silicon dioxide (MOSi₂) and/or silicon carbide (SiC).

In a further advantageous embodiment, it is provided that the heating elements are surrounded by thermal insulation elements, which extend in a manner known per se in such a way that they surround the heating chamber and the heating elements, and that in particular the heating elements are spaced apart and are thermally separated from one another.

Further advantages, details and features result from the description below relating to two exemplary embodiments with reference to the drawing, in which:

### BRIEF DESCRIPTION OF THE FIGURES

FIG. 1 shows a schematic circuit diagram of an already known firing furnace for dental purposes;

FIG. 2 shows a circuit diagram of an embodiment of a firing furnace according to the invention;

FIG. 3 shows a schematic illustration of the heating element arrangement of firing furnace according to the invention; and

FIG. 4 shows a schematic illustration of a further embodiment of a firing furnace according to the invention, and the illustration of the heating element arrangement.

### DETAILED DESCRIPTION

A dental furnace 10 is illustrated schematically in terms of its wiring. In this case the furnace is an already known dental furnace with four heating elements 12, which are arranged in a conventional manner in such a way that they surround a heating chamber in the form of a spiral or ring.

The heating elements 12 are connected in series. The voltage supply takes place via electrical terminals 14 and a switched mode power supply 16. The switched mode power supply 16 can be constructed in a conventional manner with a transformer, a rectifier and at least one filter capacitor, but can also be in the form of a so-called primary-pulsed switched mode power supply, in which a TRIAC 18 is combined with a high-frequency transformer 20. Such a switched mode power supply 16 has improved efficiency and is lighter.

The control of the heating elements takes place via a control apparatus 22, which is connected in series with the heating elements 12, with the result that the heating current flows through it.

The heating power output at first by the heating elements can be controlled via temperature sensors in the interior of the furnace hood.

Wiring for a dental furnace 10 with a configuration in accordance with the invention by way of contrast is illustrated in FIG. 2.

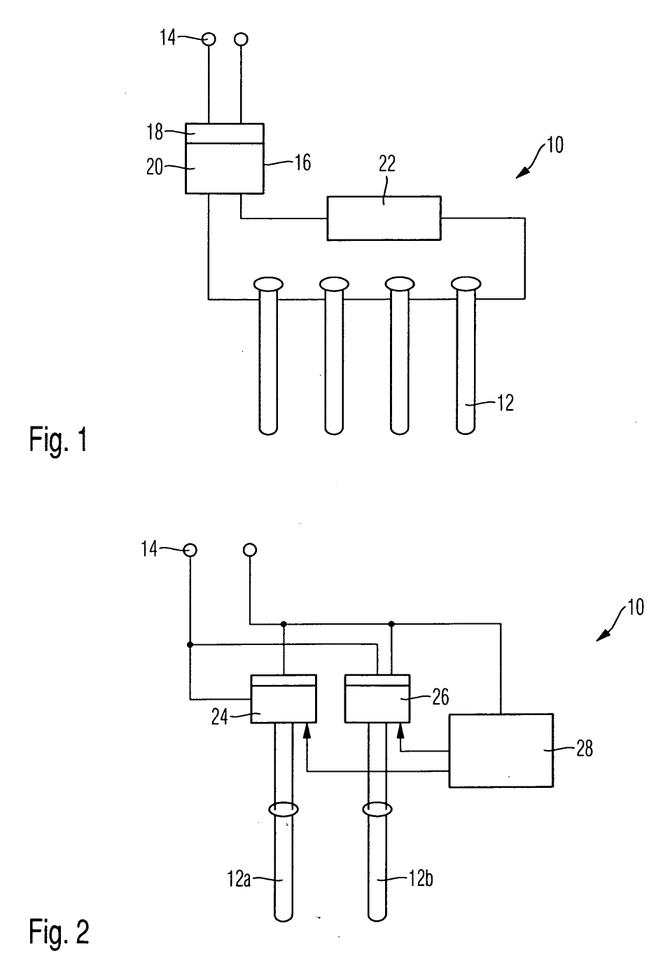

For each heating element 12a, 12b, an individual controller 24 or 26, which forms, together with the overall controller 28, the control apparatus 22, is connected directly to the mains system. Each individual controller 24 and 26 has a TRIAC 18 and a transformer 20, to this extent the heating element 12a or 12b in question being supplied directly from the mains system, and to this extent should only be able to arise in the TRIAC in question or in the transformer, but not in a further switching element as in the case of the control apparatus 22 shown in FIG. 1.

The overall controller 28 serves the purpose of controlling the ratio of the powers to be output by the individual controllers 24 and 26 precisely and possibly also in accordance with the operator's preset requirements. For this purpose, the overall controller 28 also has terminals for temperature sensors (not illustrated in any of the figures) or possibly also current sensors, which detect the output power of the individual controller 24 or 26, with the result that to this extent evaluation is also possible.

It goes without saying that for example the ratio of the output heating elements 12a or 12b can be set in each case via corresponding control elements, even if this is not illustrated in FIG. 2.

The invention provides that the two individual controllers and therefore the control apparatus 22 are controlled in such a way that the temperature distribution in the heating chamber is achieved in the desired manner. For example, a predetermined temperature level can be set, or it is possible to counteract the regularly adjusted temperature distribution in a heating chamber by means of activating upper heating elements to a lesser extent and activating lower heating elements to a greater extent and therefore to achieve increased uniformity of the temperature in the heating chamber.

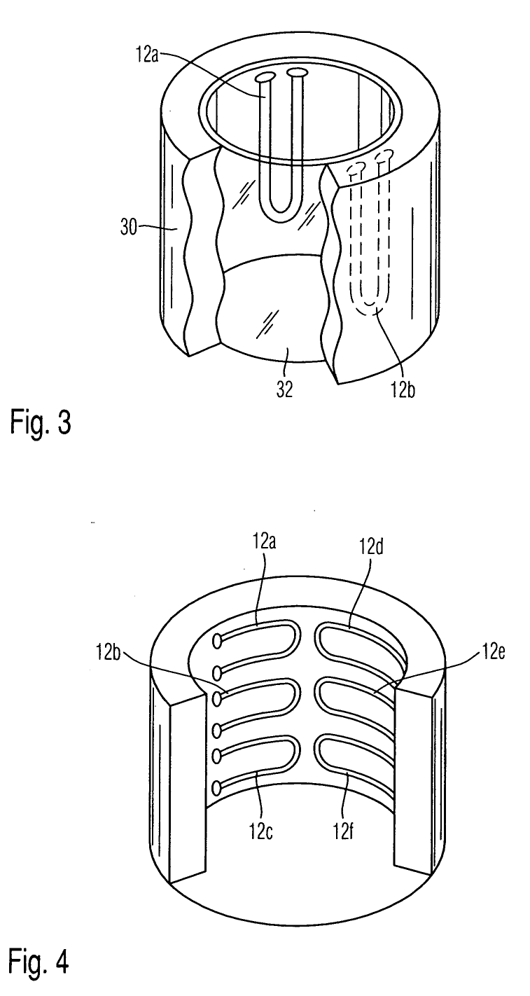

FIG. 3 shows the way in which two heating elements 12a and 12b can be arranged. Therein, a heating chamber 30 is provided which extends in the manner of a flat hollow cylinder and is covered on the outside by a quartz glass disk 32. In the quartz glass disk, the heating elements 12a and 12b extend at mutually opposing points. With this arrangement, vertical temperature stratification is not possible, but horizontal temperature distribution is. The heating elements extend substantially in the form of fingers or in the form of a U, as is known per se, and pass through the quartz glass disk 32 at their terminals.

FIG. 4 shows a modified configuration with six heating elements 12a, 12b, 12c, 12d, 12e and 12f. In this case, the heating elements 12a to 12f each extend in the form of a partial circle and in each case assume approximately a semicircle around the heating chamber. The heating elements 12a, 12b and 12c are each arranged one above the other. The same applies to the heating elements 12d to 12f.

With this solution, it is possible, for example, to activate the heating element 12c to a greater extent and the heating element 12a in order to counteract temperature gradients which are set in the heating chamber.

It is also possible to achieve any desired other temperature distribution in the heating chamber if this is desirable.

While dental firing furnaces with furnace hoods are illustrated here which accommodate the heating chamber and which are mounted in such a way that they can perform a linear movement or a pivoting movement with respect to a firing furnace lower part, which provides a bearing surface for the dental ceramic, it goes without saying that, instead of this, dental firing furnaces with a door can also be configured in accordance with the invention. In this case too, a desired temperature distribution can be set in accordance with the wishes and requirements of the operator.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the terms as used in the claims are intended to include not only the designs illustrated in the drawings of this application and the equivalent designs discussed in the text, but are also intended to cover other equivalents now known to those skilled in the art, or those equivalents which may become known to those skilled in the art in the future.

What is claimed is:

1. A dental furnace comprising:
a heating chamber (30) provided with at least two heating elements (12) acting on the heating chamber; and
one control apparatus (22) which interacts with the heating elements (12) for the voltage supply to the heating elements;
wherein the control apparatus (22) supplies the at least two heating elements (12) separately with voltage, and wherein the control apparatus (22) matches the power output of at least one heating element (12) to the requirements of the temperature distribution in the heating chamber (30).

2. The dental furnace as claimed in claim 1, wherein the heating chamber (30) extends substantially in the form of a hollow cylinder, and at least two heating elements (12) are arranged one above the other and can each be controlled separately by the control apparatus (22).

3. The dental furnace as claimed in claim 1, wherein the heating chamber (30) is formed as part of a furnace hood and is substantially closed when the furnace hood is closed.

4. The dental furnace as claimed in claim 1, wherein the heating elements (12) are arranged distributed in the region of a heating chamber wall.

5. The dental furnace as claimed in claim 4, wherein the heating elements (12) extend at least partially along the heating chamber wall in the circumferential direction of the heating chamber wall or parallel to the mid-longitudinal axis of the heating chamber wall.

6. The dental furnace as claimed in claim 1, wherein the heating elements (12) tightly adjacent to the heating chamber (30) in the form of heating spirals extend in the form of a ring or in the form of a spiral around the heating chamber (30).

7. The dental furnace as claimed in claim 1, wherein the control apparatus (22) is connected to at least one temperature sensor, which is arranged adjacent to the heating element in the heating chamber (30) and/or spaced apart from the heating element in the heating chamber (30).

8. The dental furnace as claimed in claim 1, wherein heating elements (12) are supplied with an identical or higher power by the control apparatus (22).

9. The dental furnace as claimed in claim 7, wherein a temperature of a maximum of 1600° C. can be measured by the sensor.

10. The dental furnace as claimed in claim 1, wherein the control apparatus (22) for the power supply to the heating elements (12) has a primary-pulsed switched mode power supply (16), with a separate circuit being provided in particular for each or a plurality of heating elements, which circuits can be controlled jointly by the control apparatus (22).

12. The dental furnace as claimed in claim 1, wherein the heating elements (12) substantially comprise molybdenum silicon dioxide (MOSi₂) and/or silicon carbide (SiC).

13. The dental furnace as claimed in claim 1, wherein the heating elements (12) are surrounded by thermal insulation elements, which extend in such a way that they surround the heating chamber and the heating elements (12), and wherein in particular the heating elements (12) are spaced apart and are thermally separated from one another.
